(19) United States
(12) Patent Application Publication
(10) Pub. No.: US 2008/0091492 A1
(43) Pub. Date: Apr. 17, 2008

(54) Web-enabled deliverable-gate program management with scoring method for product development processes

(76) Inventor: Steven B. Bowler, Hudson, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/418,367

(22) Filed: Apr. 18, 2003

Related U.S. Application Data
(60) Provisional application No. 60/374,013, filed on Apr. 19, 2002.

(51) Int. Cl. G05B 19/418

(52) U.S. Cl. 705/8

(57) ABSTRACT

The Deliverable is a schedule entity, related to program management of new product development that also links a user to the intellectual property being developed in the course of a scheduled product development effort. The Deliverable has a due date, owner, and parent project. The Gate object signifies the end of a major Phase or sub-Phase of the Program and has links to all required Deliverables in a checklist-type display that includes the status of each required Deliverable. In many industries, such as aerospace, scoring is applied as an ongoing metric for Deliverables, which yields an overall score at each Gate to measure improvement in the creation of Deliverables as standard processes are reused.

### CROSS REFERENCE TO RELATED APPLICATIONS

Applicant claims priority of U.S. Provisional Patent Application in the name of Steven B. BOWLER, application No. 60/374,013, filed Apr. 19, 2002.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to the use of Internet software to enable collaborative program management for new product development. Program management entails the scheduling of activities and their interdependencies, raising and resolving issues, managing the creation and release of critical intellectual property, building prototypes, and releasing products to full production. The overall product life cycle is managed in this manner from concept through end-of-life. Numerous risk management techniques are employed in program management that may not be present in more ubiquitous project management. The use of metrics, problem logs, alerts, team meetings, Phase exit reviews, and audits are used to keep large-scale Programs on track, put them on hold, or kill them altogether in order to minimize loss. The invention fits inside the management of Deliverables and the Phase-exit review, which is commonly called a Gate.

2. Description of Prior Art

Terminology.

A “Program” is a project to be managed that consists of Phases, Gates, and Deliverables.

A “Phase” is a major time-based grouping of scheduled activities in a Program and is a summary task that culminates in a major milestone called a Gate.

A “Gate” is a major milestone of a Program denoting the end of a Phase. To pass through a Gate, certain conditions must be met such as the adequate completion of assigned Deliverables, the closure of major problems or issues, the completion of assigned tasks, and any other checklists that may be presented.

“Artifacts” may be documents, forms, drawings, or attachments necessary for the completion of a Program.

A “Deliverable” is an Artifact or group of Artifacts that may be documents, forms, drawings, or attachments necessary for the completion of a Program.

A “Template” is a previously developed schedule, a set of established activities and their dependencies, which may be reused on multiple Programs.

Overview of Program Management

In the early 1980s, companies began to apply project management principles such as Gantt charts and pert charts to complex product development projects. Such schedules were generated by hand for the most part. Problems that arose were dealt with through a series of meetings and assigned actions by project managers. Quality control procedures were developed, along with forms and audit groups, to make sure that assigned work was completed properly. Design data and drawings were largely created by hand on manual drafting boards in a drafting department. Copies were often made by hand also.

The first wave of the application of technology to attack the problem in the mid 1980s was the creation of stand-alone desktop software applications for Personal Computers (PCs), which were then becoming ubiquitous on individuals' desktops. Some mainframe systems also were put into use to capture cost information. The first Project Management applications for the IBM PC and Macintosh were developed with some rudimentary graphics for displaying Gantt charts. Spreadsheets and Word Processor applications were often employed to record problems or issues in a kind of ad hoc log system.

Quality Control applications also began to appear to create and store procedures and manage audit schedules and criteria. The advent of commercial quality standards, such as ISO 9000, led to a burgeoning software industry to handle the various requirements of the standards. Computer Aided Design (CAD) applications sprang up at about the same time allowing designers to create and store libraries of design documents that could be easily modified or reproduced.

In the early 1990s, more mainframe applications were released to share labor data and manufacturing information such as Bills of Materials. Client-server applications were also beginning to appear in the marketplace at this time. Project Management applications were still largely PC-based and included new features such as resource visualization and leveling.

By the mid-1990s, Personal Information Managers (PIMs) were being introduced by companies such as Lotus and Microsoft to manage tasks and calendars on individuals' PCs. Electronic mail was beginning to become more prevalent for notifying people of their assignments and issues. Drawing vaults and Product Data Management (PDM) applications were now allowing some minimal amount of collaboration on design work by sharing CAD files in a client-server architecture. More quality control software was also being employed to monitor the manufacturing process.

As the prevailing architecture shifted from client-server to the Internet, software entrepreneurs envisioned the ability to share vital information across geographic and company boundaries. The first applications were essentially web page bulletin boards to notify people of key events and issues. Standards designed to more tightly control activities also were shared in this manner. As the price of Internet bandwidth decreased and as availability of bandwidth increased, protocols such as File Transfer Protocol (FTP) allowed engineers to upload and download large CAD drawings to and from remote locations. As active elements were added to these early Internet-based systems, some process automation was added as well to link events to mail, create links to documents, allow restricted login, and add underlying databases of critical information. The idea of collaboration was taking off. Project Management software was soon being developed for the Web. Early iterations were often pictures of schedules created from desktop applications such as Microsoft Project. Users could see, but not alter, schedule and status data. Likewise, quality control and PIM applications were being written for the Internet. PDM companies were adding web interfaces to their drawing vaults to allow team members around the world to share data via the Internet.

Meanwhile, major consulting companies such as Deloitte-Touche, PriceWaterhouseCoopers, KPMG, and Andersen were advising their clients to implement best practice processes for product development that utilized concepts such as Phases, Deliverables, and Gates that were not found in existing project management software applications. These processes usually resided in hard-copy format only, such as three-ring binders, and they went partially or completely unimplemented for want of a suitable enabler to implement these robust practices. Clients were left to improvise schedules, issue management, quality control, and intellectual property sharing using a kluge of existing PC applications.

Patents.

U.S. Pat. No. 5,563,994 (Harmon et al., Oct. 8, 1996) discloses a system for graphically generating the sequence and temporal relationship between tasks in a project.

U.S. Pat. No. 5,594,639 (Atsumi, Jan. 14, 1997) discloses an order processing control module.

U.S. Pat. No. 5,692,157 (Williams, Nov. 25, 1997) discloses a method and system for transferring data between objects using registered data formats.

U.S. Pat. No. 5,724,262 (Ghahramani, Mar. 3, 1998) discloses a method for measuring the usability of a system and for task analysis and re-engineering.

U.S. Pat. No. 5,745,110 (Ertemalp, Apr. 28, 1998) discloses a method and apparatus for arranging and displaying task schedule information in a calendar view format.

U.S. Pat. No. 5,818,715 (Marshall et al., Oct. 6, 1998) discloses a method and system for efficiently modifying a project model in response to an update to the project model.

U.S. Pat. No. 5,826,236 (Narimatsu et al., 10-20-1998) discloses a method for allocating resources and processes for design and production plan scheduling.

U.S. Pat. No. 5,835,898 (Borg et al., Nov. 10, 1998) discloses a visual schedule management system for a manufacturing facility.

U.S. Pat. No. 5,905,884 (Williams, May 18, 1999) discloses a method and system for registering and retrieving data formats for objects using a persistent registry.

U.S. Pat. No. 5,907,490 (Oliver, May 25, 1999) discloses a system and method for project management and assessment.

U.S. Pat. No. 6,216,109 (Zweben et al., Apr. 10, 2001) discloses an iterative repair optimization with particular application to scheduling for integrated capacity and inventory planning.

U.S. Pat. No. 6,292,830 (Taylor et al., Sep. 18, 2001) discloses a system for optimizing interaction among agents acting on multiple levels.

U.S. Pat. No. 6,335,733 (Keren et al., Jan. 1, 2002) discloses a method and system for displaying and editing a resource schedule.

All of the above patents discuss program or project management referencing methods such as pert and Gantt charts, but none of the above patents discusses the use of Phases, Gates, and Deliverables in program or project management.

What is needed, therefore, is a product development platform that operates in a client-server mode, is Internet-based, is consistent with industry standards (such as Phases, Deliverables, and Gates), and provides combinations of file privileges (i.e. read, write, and execute) capabilities to end users.

### BRIEF SUMMARY OF THE INVENTION

In 1999, ProductFactory, Inc. was spun off from Workgroup Technology Corporation and began the development and release of Internet software for program management of new product development. At the core of its mission was to “operationalize” the above-mentioned best practice processes into a suite of integrated applications. The Phase-Gate-Deliverable concept was written into the applications in a manner that would be intuitive to end users and would use the latest technologies to graphically represent Program status, Deliverable status, “Gate health,” unresolved issues, audit status, ownership, and resource utilization.

The ProductFactory program management application adds a Deliverable on the Program schedule to solve the problem of integration of the schedule and the intellectual property being created. Artifacts such as drawings, forms, and procedures are added to the Deliverable in a manner that makes them available to authorized users who may be dependent on them. Quality Control assigns a weight to the Artifact and then applies a score, which rolls up to a Deliverable score that can be compared to a standard. Links, in the form of dependencies, are established to Gates which are “super milestones” marking the end of a major Phase of the Program. The Gate displays the linkages as well as the scoring from all dependent Deliverables, which then rolls up into a Gate score for the Phase.

Management uses all of this information to assist with decisions regarding possible rework of Deliverables, go/hold/kill decisions for the Program, and other risk management alternatives that may be available to them. Throughout the process, there is integration with e-mail, which alerts team members and management of events related to schedule, risk, and issues. The ProductFactory solution, then, integrates all of the previous fragmented solutions to program management in a comprehensive application suite utilizing the latest available technologies to operationalize best practices for program management of new product development.

Objects

The Deliverable and Gate with scoring method is designed to allow easy measurement and response to the quality of each scheduled Deliverable and, combined with the scores of other Deliverables that are linked to the same Gate, provide a quality metric for a Phase of a Program that can be compared with a threshold metric for Phases, as well as all other instances of the same Phase on other Programs. Weights are supplied to distinguish the importance of Deliverables relative to one another. A historical Program metric can then be referenced for continuous improvement of the product development process.

The way this is done is that each Deliverable object, which is a software entity, has built into it a data input method for the Deliverable score. This score is displayed both as a number and as a color. The input may be made by the Deliverable owner or by a separate audit function. This then provides the Deliverable score.

Gates have a normalized score from all Deliverables that are dependencies to the Gate. There is a data entry for the threshold score for the Gate. The scoring algorithm is the arithmetic average of the required Deliverables. This provides a single numerical score to compare against the threshold score. Graphics are provided which show the scatter of the individual Deliverable scores as well as the Gate score against the supplied threshold and an indicator of risk.

Features

The Phase-Gate-Deliverable application utilizes a Java 2 Enterprise Edition architecture with an enterprise class database operating from a web server. The user interface is Hypertext Markup Language (HTML) with active elements connecting it via Java Database Controller (JDBC) software to the database.

The Deliverable object is an interface with links to schedule and status information. Dependencies to Gate objects can be established. The Deliverables and Gates have assigned owners selected from a Program team member list. Artifacts are added to the Deliverable and when auditing is involved, a weight is assigned to the Artifact. As the Artifact matures, and as the Gate due date approaches, a score is applied by the audit entity. An overall score is computed from the Artifact scores and displayed graphically. One graph is an indicator of the Deliverable score, another is a histogram of all the individual scores for which ratings have been applied.

A Gate object denotes the end of a Phase of the Program. It has a due date and status and has a summary of the Deliverables from that Phase that have been designated as dependencies to the Gate. The scores from these Deliverables is used to compute a Gate score. Weights for the different Deliverables are established in the Gate. The score for the Gate is used for decision support at Phase exit reviews and for management attention when reviewing the Program's progress. Metrics and reports are established to compare Gate scores to previous Programs and to establish continuous improvement monitoring.

Advantages

There are many advantages to the invention, including the following. Other advantages will be apparent to those skilled in the art.

The Gate-Deliverable scoring method takes a process that has historically been manually measured and subjectively monitored and applies a statistical, scientific methodology to it for the reduction of risk.

The application integrates into one place all schedule information, drawing and document status, issues management, e-mail alerts, quality procedures, and related best practice data. The Gate and Deliverable work together to apply the highly scientific risk management decision support.

### BRIEF DESCRIPTION OF THE DRAWINGS

FIG. 1 is a graphical representation of the history of the development of project management and program management solutions.

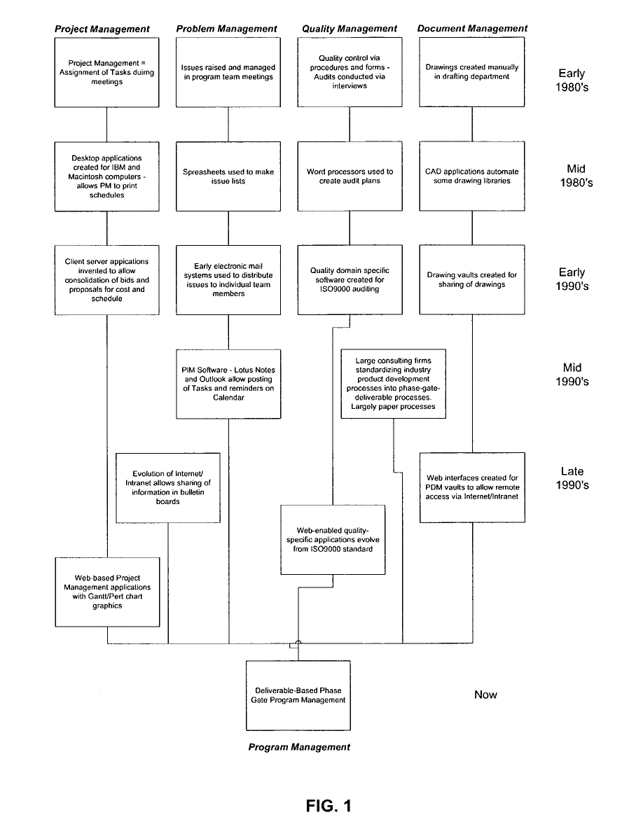

FIG. 2 shows the Gate and Deliverable summary screens modified with the addition of scoring and graphics. Individual scores from Deliverables are compiled at the Gate to provide a “health” indication for that Phase of the Program. At a glance, the program manager and other interested parties can determine if the Gate meets it required threshold score and, if not, where (i.e. in which Deliverable(s)) the problem originates.

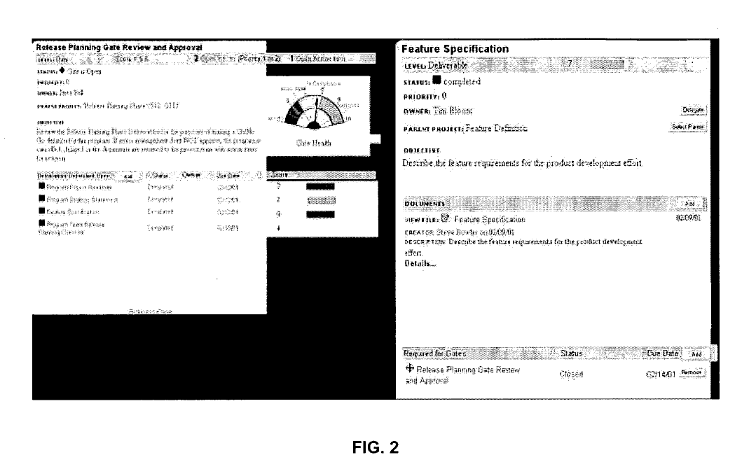

FIG. 3 shows a bar chart depicting the rankings of Deliverables for a Gate.

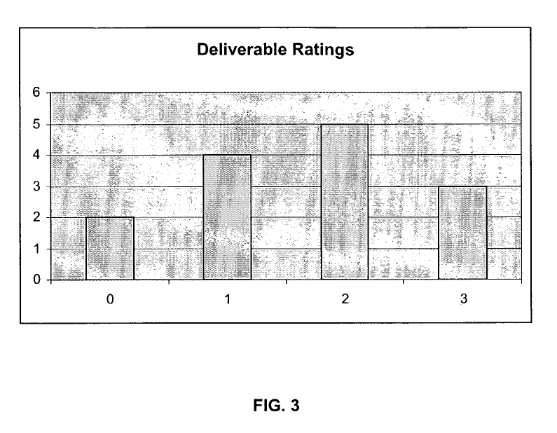

FIG. 4 shows the overall flow of the invention.

### DETAILED DESCRIPTION OF THE INVENTION, INCLUDING THE PREFERRED EMBODIMENT

A Program plan consisting of Deliverables and Gates is created. Each Deliverable is given a weight of 0-10 based on importance of the Deliverable for that Phase of the Program.

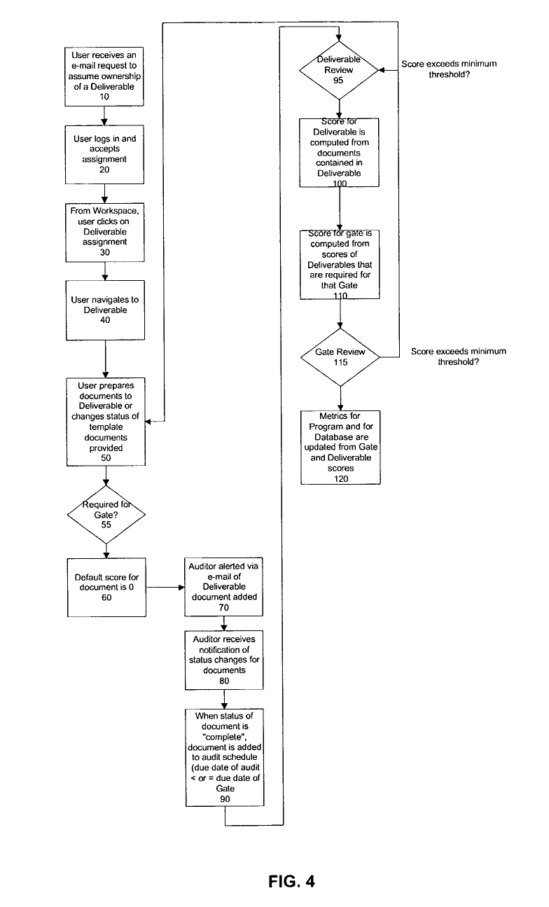

Referring now to FIG. 4.

In Step 10, a user, typically a team member of a product development program, receives a notification via e-mail that they have been assigned as the owner of a Deliverable for the Program.

In Step 20, the user logs into the software with a username and password assigned by the system administrator and accepts ownership of the Deliverable.

In Step 30, the Deliverable now appears on the user's personal assignment list.

In Step 40, the user navigates to the Deliverable.

In Step 50, the user can view a predetermined list of documents or the user can add documents to complete the Deliverable.

In Step 55, a decision is made by an audit or management entity that a Deliverable is required for a Phase-Gate and, if so, a linkage is established.

In Step 60, documents are assigned an initial score of zero, and the user prepares the documents and changes the status of the documents from a draft or incomplete status to a completed or released status.

In Step 70, an auditor is notified by e-mail if any documents are added as Deliverables.

In Step 80, an auditor is notified when the status of the document has changed to “completed” or “released.”

In Step 90, documents whose status has changed to “complete” are added to an audit schedule log. The due date for the audit is the same as the due date for the Phase-Gate.

In Step 95, required Deliverables are then audited prior to or at a Gate Review. A score of 0, 1, 2, or 3 is applied to each required document for the Deliverable and an overall score for the Deliverable is computed by multiplying the score times the weight of each document and then dividing by the total possible score. This score is compared to a threshold score set by the audit entity for the business. If the score is deemed inadequate, the Deliverable owner(s) are notified and the documents are reworked and re-audited until reaching a satisfactory score. If the Deliverable fails the deliverable review, return to Step 50. Otherwise, go on to Step 100.

In Step 100, each Deliverable is subjected to a Deliverable review as in Step 95.

In Step 110, a score for each Gate is computed from the scores of required Deliverables that are required for that Gate through simple averaging.

In Step 115, the Gate review, Gate scores are compared to a business threshold and to historical Gate metrics. Documents and Deliverables may be reworked to provide an improved score. If a Gate fails a Gate review, return to Step 50. Otherwise, go on to Step 120.

In Step 120, metrics for the Program are updated from Gate and Deliverable scores.

I claim:

1. A method of managing a Program, said method comprising:
Dividing said Program into one or more Phases;
Assigning one or more Gates to each of said Phases;
Linking any number of Deliverables to one or more of said Gates of said Program,
whereby said Linking creates Required Deliverables; and
Computing metrics for each of said Deliverables, said Gates, and said Phases of said Program.

2. The method of claim 1 wherein said Assigning also includes:
conducting a Gate Review for each of said Gates of said Phases by computing a Gate Score for each of said Gates and comparing said Gate Score to a Threshold Gate Score for each of said Gates,
wherein said Gate Score is the average score of said Required Deliverables for each of said Gates,
whereby each of said Gates is deemed to have passed said Gate Review if said Gate Score meets or exceed said Threshold Gate Score.

3. The method of claim 1 wherein said Linking also includes:
conducting a Deliverable Review for each of said Required Deliverables by computing a Deliverable Score for each of said Required Deliverables and comparing said Deliverable Score to a Threshold Deliverable Score for each of said Required Deliverables,
whereby each of said Required Deliverables is deemed to have passed said Deliverable Review if said Deliverable Score meets or exceeds said Threshold Deliverable Score.

4. A method of managing a Program, said method comprising:
Dividing said Program into one or more Phases;
Assigning one or more Gates to each of said Phases,
wherein said Assigning also includes:
conducting a Gate Review for each of said Gates of said Phases by computing a Gate Score for each of said Gates and comparing said Gate Score to a Threshold Gate Score for each of said Gates,
whereby each of said Gates is deemed to have passed said Gate Review if said Gate Score meets or exceeds said Threshold Gate Score.
Linking any number of Deliverables to one or more of said Gates of said Program,
whereby said Linking creates Required Deliverables;
wherein said Linking also includes:
conducting a Deliverable Review for each of said Required Deliverables by computing a Deliverable Score for each of said Required Deliverables and comparing said Deliverable Score to a Threshold Deliverable Score for each of said Required Deliverables,
whereby each of said Required Deliverables is deemed to have passed said Deliverable Review if said Deliverable Score meets or exceeds said Threshold Deliverable Score; and
Computing metrics for each of said Deliverables, said Gates, and said Phases of said Program.

5. A method of managing a Program said method comprising:
Dividing said Program into one or more Phases;
Assigning one or more Gates to each of said Phases;
Linking any number of Deliverables to one or more of said Gates of said Program,
whereby said linking creates Required Deliverables;
Adding Artifacts to each of said Deliverables; and
Computing metrics for each of said Artifacts, said Deliverables, said Gates, and said Phases of said Program.

6. The method of claim 5 wherein said Assigning also includes:
conducting a Gate Review for each of said Gates of said Phases by computing a Gate Score for each of said Gates and comparing said Gate Score to a Threshold Gate Score for each of said Gates,
wherein said Gate Score is the average score of said Required Deliverables for each of said Gates,
whereby each of said Gates is deemed to have passed said Gate Review if said Gate Score meets or exceed said Threshold Gate Score.

7. The method of claim 5 wherein said Linking also includes:
conducting a Deliverable Review for each of said Required Deliverables by computing a Deliverable Score for each of said Required Deliverables and comparing said Deliverable Score to a Threshold Deliverable Score for each of said Required Deliverables,
whereby each of said Required Deliverables is deemed to have passed said Deliverable Review if said Deliverable Score meets or exceeds said Threshold Deliverable Score.

8. A method of managing a Program said method comprising:
Dividing said Program into one or more Phases;
Assigning one or more Gates to each of said Phases,
wherein said Assigning also includes:
conducting a Gate Review for each of said Gates of said Phases by computing a Gate Score for each of said Gates and comparing said Gate Score to a Threshold Gate Score for each of said Gates,
whereby each of said Gates is deemed to have passed said Gate Review if said Gate Score meets or exceeds said Threshold Gate Score;
Linking any number of Deliverables to one or more of said Gates of said Program,
whereby said linking creates Required Deliverables,
wherein said Linking also includes:
conducting a Deliverable Review for each of said Required Deliverables by computing a Deliverable Score for each of said Required Deliverables and comparing said Deliverable Score to a Threshold Deliverable Score for each of said Required Deliverables,
whereby each of said Required Deliverables is deemed to have passed said Deliverable Review if said Deliverable Score meets or exceeds said Threshold Deliverable Score; and
Adding Artifacts to each of said Deliverables;
Computing metrics for each of said Artifacts, said Deliverables, said Gates, and said Phases of said Program.

9. A method of managing a Program having Phases, Gates, and Deliverables, said method comprising:
Assigning a Weight to each of said Deliverables in each of said Phases of said Program,
wherein said Weight of each of said Deliverables is based on the importance each of said Deliverables to each of said Phases of said Program;
Delivering a Notification to an Owner of each of said Deliverables;
Adding one or more Artifacts to each of said Deliverables,
wherein each of said Artifacts has an assigned Artifact Weight and an assigned Artifact Score;
Linking any number of said Deliverables to one or more of said Gates of said Program,
whereby said linking creates Required Deliverables;
Conducting a Deliverable Review for each of said Required Deliverables by computing a Deliverable Score for each of said Required Deliverables and comparing said Deliverable Score to a Threshold Deliverable Score for each of said Required Deliverables,
wherein said Deliverable Score is the weighted average of the product of said Artifact Weight and said Artifact Score of each of said Artifacts of each of said Deliverables,
whereby each of said Required Deliverables is deemed to have passed said Deliverable Review if said Deliverable Score meets or exceeds said Threshold Deliverable Score;
Conducting a Gate Review for each of said Gates of said Phases by computing a Gate Score for each of said Gates and comparing said Gate Score to a Threshold Gate Score for each of said Gates,
wherein said Gate Score is the average score of said Required Deliverables for each of said Gates,
whereby each of said Gates is deemed to have passed said Gate Review if said Gate Score meets or exceeds said Threshold Gate Score; and
Computing metrics for each of said Artifacts, said Deliverables, said Gates, and said Phases of said Program.

10. A system for managing a Program, said system comprising:
A processor programmed for:
Dividing said Program into one or more Phases;
Assigning one or more Gates to each of said Phases;
Linking any number of said Deliverables to one or more of said Gates of said Program,
whereby said Linking creates Required Deliverables; and
Computing metrics for each of said Documents, said Gates, and said Phases of said Program.

11. A system for managing a Program having Phases, Gates, and Deliverables, said system comprising:
A processor programmed for:
Assigning a Weight to each of said Deliverables in each of said Phases of said Program,
wherein said Weight of each of said Deliverables is based on the importance each of said Deliverables to each of said Phases of said Program;
Delivering a Notification to an Owner of each of said Deliverables;
Adding one or more Artifacts to each of said Deliverables,
wherein each of said Artifacts has an assigned Artifact Weight and an assigned Artifact Score;
Linking any number of said Deliverables to one or more of said Gates of said Program,
whereby said linking creates Required Deliverables;
Conducting a Deliverable Review for each of said Required Deliverables by computing a Deliverable Score for each of said Required Deliverables and comparing said Deliverable Score to a Threshold Deliverable Score for each of said Required Deliverables,
wherein said Deliverable Score is the weighted average of the product of said Artifact Weight and said Artifact Score of each of said Artifacts of each of said Deliverables,
whereby each of said Required Deliverables is deemed to have passed said Deliverable Review if said Deliverable Score meets or exceeds said Threshold Deliverable Score;
Conducting a Gate Review for each of said Gates of said Phases by computing a Gate Score for each of said Gates and comparing said Gate Score to a Threshold Gate Score for each of said Gates,
wherein said Gate Score is the average score of said Required Deliverables for each of said Gates,
whereby each of said Gates is deemed to have passed said Gate Review if said Gate Score meets or exceed said Threshold Gate Score; and
Computing metrics for each of said Artifacts, said Documents, said Gates, and said Phases of said Program.

12. A computer-readable medium having computer-executable instructions for a method of managing a Program, said method comprising:
Dividing said Program into one or more Phases;
Assigning one or more Gates to each of said Phases;
Linking any number of said Deliverables to one or more of said Gates of said Program,
whereby said Linking creates Required Deliverables; and
Computing metrics for each of said Documents, said Gates, and said Phases of said Program.

13. A computer-readable medium having computer-executable instructions for a method of managing a Program having Phases, Gates, and Deliverables, said method comprising:
Assigning a Weight to each of said Deliverables in each of said Phases of said Program,
wherein said Weight of each of said Deliverables is based on the importance each of said Deliverables to each of said Phases of said Program;
Delivering a Notification to an Owner of each of said Deliverables;
Adding one or more Artifacts to each of said Deliverables,
wherein each of said Artifacts has an assigned Artifact Weight and an assigned Artifact Score;
Linking any number of said Deliverables to one or more of said Gates of said Program,
whereby said linking creates Required Deliverables;
Conducting a Deliverable Review for each of said Required Deliverables by computing a Deliverable Score for each of said Required Deliverables and comparing said Deliverable Score to a Threshold Deliverable Score for each of said Required Deliverables,
wherein said Deliverable Score is the weighted average of the product of said Artifact Weight and said Artifact Score of each of said Artifacts of each of said Deliverables,
whereby each of said Required Deliverables is deemed to have passed said Deliverable Review if said Deliverable Score meets or exceeds said Threshold Deliverable Score;
Conducting a Gate Review for each of said Gates of said Phases by computing a Gate Score for each of said Gates and comparing said Gate Score to a Threshold Gate Score for each of said Gates,
wherein said Gate Score is the average score of said Required Deliverables for each of said Gates,
whereby each of said Gates is deemed to have passed said Gate Review if said Gate Score meets or exceed said Threshold Gate Score; and
Computing metrics for each of said Artifacts, said Documents, said Gates, and said Phases of said Program.
